(19) United States
(12) Patent Application Publication
(10) Pub. No.: US 2015/0207880 A1
(43) Pub. Date: Jul. 23, 2015

(54) APPARATUS AND METHOD FOR DISTRIBUTION PROCESSING OF DATA, AND STORAGE SERVER

(71) Applicant: Electronics and Telecommunications Research Institute, Daejeon (KR)

(72) Inventors: Ki Sung JIN, Iksan-si (KR); Hong Yeon KIM, Daejeon (KR); Young Kyun KIM, Daejeon (KR)

(73) Assignee: Electronics and Telecommunications Research Institute, Daejeon (KR)

(21) Appl. No.: 14/484,607

(22) Filed: Sep. 12, 2014

(30) Foreign Application Priority Data
Jan. 20, 2014 (KR) 10-2014-0006562

(51) Int. Cl. H04L 29/08; G06F 11/20

(52) U.S. Cl. CPC H04L 67/1097; H04L 67/322; G06F 11/2007

(57) ABSTRACT

Disclosed are an apparatus and a method for distribution processing of data, and a storage server and the apparatus for distribution processing of data includes: a metadata management unit providing metadata information corresponding to data to a metadata server to verify information of an original storage server and one or more copy storage servers to store the data from the metadata server; and a data management unit creating a message including the information on the storage servers verified by the metadata management unit and the data, and transmitting the message to a storage server having a higher priority according to priorities of the storage servers to store the corresponding data.

### CROSS-REFERENCE TO RELATED APPLICATIONS

This application claims priority to and the benefit of Korean Patent Application No. 10-2014-0006562 filed in the Korean Intellectual Property Office on Jan. 20, 2014, the entire contents of which are incorporated herein by reference.

### TECHNICAL FIELD

The present invention relates to an apparatus and a method for distribution processing of data, and a storage server, and more particularly, to a technology that distributes data and asynchronously stores and manages the distributed data in a plurality of storage servers.

### BACKGROUND ART

In a storage system or a file system, improvement of extensibility and performance of the storage system is subjected to technological development.

In recent years, attempted is an effort for improving the extensibility and the performance of the storage system by separating a data input/output path of a file and a metadata management path of the file in a storage structure. Such a structure may allow a client system to directly access storage devices, and improve the extensibility of the storage by avoiding a bottleneck spot which occurs due to a frequent access of the file.

In particular, in the distribution storage, when data is created, the data is not stored in only one storage server and but copied and stored in a plurality of storage servers as a copy in order to assure reliability for a server failure. In this case, even when a failure occurs in the server, the access through copy data is enabled to assure availability for user data.

However, in the case of a scheme in which data is directly transmitted to each storage server from a client server, and a response for a result is received from the corresponding storage server and thereafter, data is transmitted to a subsequent storage server, since the scheme is completed only after receiving the response for the result according to the order of the respective storage servers in order to record one datum, a response time for a recording request from a user may be delayed. Since data is transmitted to each of all storage servers through a network from the client server, network efficiency of the client server may deteriorate.

In a scheme in which data is transmitted to only a storage server to store original data from the client server, the storage server to store the original data transmits data for each storage server to store the copy data and finally returns processing results to the client server after receiving all of the processing results. In this case, since data is transmitted to only one storage server from the client server, network efficiency of the client server does not deteriorate, but since the processing results are sequentially received from all of the storage servers, a processing delay problem regarding the use recording request has still occurred.

### SUMMARY OF THE INVENTION

The present invention has been made in an effort to provide an apparatus and a method for distribution processing of data that minimize a processing delay of data with asynchronously recording data even while assuring availability of data through copying by distributing and storing data in a plurality of storage servers, and a storage server.

An exemplary embodiment of the present invention provides an apparatus for distribution processing of data, including: a metadata management unit providing metadata information corresponding to data to a metadata server to verify information of an original storage server and one or more copy storage servers to store the data from the metadata server; and a data management unit creating a message including the information on the storage servers verified by the metadata management unit and the data, and transmitting the message to a storage server having a higher priority according to priorities of the storage servers to store the corresponding data.

The information on the storage servers may be implemented in a storage server list form in which the information of the respective storage servers is sequentially sorted according to the priorities of the storage servers.

In the message, the storage server list may be included in a header area and the data is included in a body area.

The information on the storage servers may include at least one of an ID and an IP of each storage server, and a replication path IP of the data included in the message.

The apparatus may further include a failure processing buffer temporarily storing the message before transmitting the message.

The apparatus may further include a failure management unit calling the message temporarily stored in the failure processing buffer to retransmit the called message to the storage server having the higher priority among residual servers other than the storage server in which the failure occurs.

The original storage server may have a higher priority than the copy storage servers.

Another exemplary embodiment of the present invention provides a storage server including: an information recognizing unit recognizing, from a message including a storage server list and data, information on a plurality of storage servers included in the storage server list; and a data processing unit extracting the data from the message and storing the extracted data in a data block and transmitting the data to the next storage server according to priorities of the plurality of storage servers recognized by the information recognizing unit.

The data processing unit may reconfigure a storage server list in which information of residual storage servers other than information on the data processing unit is sequentially sorted according to the priorities of the storage servers to transmit the reconfigured storage server list to the next storage server together with the data.

The storage server may further include a failure processing unit transmitting a disk failure state of the corresponding storage server to a data distribution processing apparatus in the case of failing to store the data due to occurrence of a failure in the data block.

The failure processing unit may transmit a network failure state of the next storage server to the data distribution processing apparatus in the case of failing to transmit the data to the next storage server.

The message may store the data and is asynchronously transmitted through a replication dedicated channel formed among the next storage servers.

Yet another exemplary embodiment of the present invention provides a method for distribution processing of data, including: providing metadata information corresponding to data to a metadata server to verify information of an original storage server and one or more copy storage servers to store the data from the metadata server; creating a message including the verified information on the storage servers and the data; temporarily storing the message in a failure processing buffer; and transmitting the message to a storage server having a higher priority according to priorities of the storage servers.

The method may further include: sensing a failure state of any one of the storage servers; and calling the message temporarily stored in the failure processing buffer and retransmitting the called message to a storage server having a higher priority among residual servers other than a storage server in which the failure occurs.

According to exemplary embodiments of the present invention, a processing delay of data can be minimized with asynchronously recording data even while assuring availability of data through coping by distributing and storing data in a plurality of storage servers.

In particular, each storage server does not perform response processing of data recording during copying data to improve a processing speed.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

Objects of the present invention are not limited the aforementioned object and other objects and advantages of the present invention, which are not mentioned can be appreciated by the following description and will be more apparently know by the exemplary embodiments of the present invention. It can be easily known that the objects and advantages of the present invention can be implemented by the means and a combination thereof described in the appended claims.

### BRIEF DESCRIPTION OF THE DRAWINGS

FIG. 1 is a diagram illustrating a configuration of a distribution system according to an exemplary embodiment of the present invention.

FIG. 2 is a block diagram illustrating a configuration of a client server according to the exemplary embodiment of the present invention.

FIG. 3 is a block diagram illustrating a configuration of a storage server according to the exemplary embodiment of the present invention.

FIG. 4 is an exemplary diagram referred in describing the structure of a message transferred among respective servers in the distribution system according to the exemplary embodiment of the present invention.

FIG. 5 is an exemplary diagram referred in describing a data copying operation of the distribution system according to the exemplary embodiment of the present invention.

FIG. 6 is an exemplary diagram illustrating a data flow of the distribution system according to the exemplary embodiment of the present invention.

FIG. 7 is an exemplary diagram illustrating an inter-storage server connection structure according to the exemplary embodiment of the present invention.

FIGS. 8A, 8B, 9A and 9B are exemplary diagrams referred in describing a failure processing operation of the distribution system according to the exemplary embodiment of the present invention.

FIGS. 10 to 12 are flowcharts illustrating an operation flow of a distribution system according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, the present invention will be described in detail with reference to the accompanying drawings. In this case, like reference numerals refer to like elements in the respective drawings. A detailed description of an already known function and/or configuration will be skipped. In contents disclosed hereinbelow, a part required for understanding an operation according to various exemplary embodiments will be described in priority and a description of elements which may obscure the spirit of the present invention will be skipped.

Some components of the drawings may be enlarged, omitted, or schematically illustrated. An actual size is not fully reflected on the size of each component and therefore, contents disclosed herein are not limited by relative sizes or intervals of the components drawn in the respective drawings.

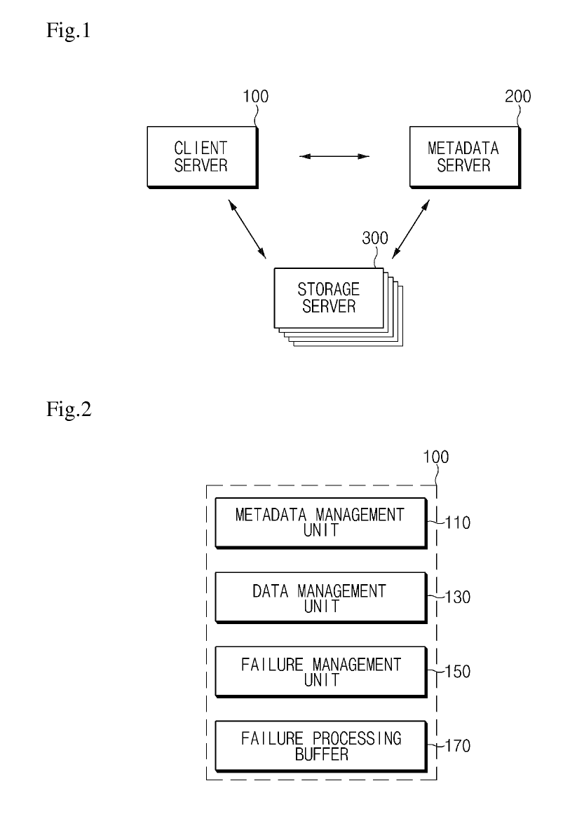

FIG. 1 is a diagram illustrating a configuration of a distribution system according to an exemplary embodiment of the present invention.

As illustrated in FIG. 1, the distribution system according to the exemplary embodiment of the present invention may include a client server 100, a metadata server 200, and a storage server. Herein, the client server 100, the metadata server 200, and the storage server 300 are respectively connected to each other through a network to transmit and receive information to and from each other. The client server 100 as an apparatus that distributes data in the distribution system may correspond to a data distribution processing apparatus disclosed in the claims. However, hereinafter, the client server 100 will be described by being designated as a client.

First, the metadata server 200 is a server that stores and manages metadata. In this case, the metadata includes attribute information including the size, a creation time, and an owner of a file. The metadata may be stored as a text-type file, for example, a txt file. The metadata server 200 may store information on the storage server 300 storing the file.

The client server 100 processes the corresponding file to be stored when there is a request for storing the file from a user. Herein, the file which is requested to be stored from the user is constituted by the metadata and the data.

The client server 100 allows information on the metadata of the file which is requested to be stored by the user to be transmitted to the metadata server 200. In this case, the metadata server 200 may provide to the client server 100 information on the storage server 300 storing the corresponding file based on the metadata information received from the client server 100.

Meanwhile, the client server 100 allows the data of the file which is requested to be stored by the user to be stored in the storage server 300. In this case, the client server 100 verifies information on a position in which the file is requested to be stored from the user, for example, information on the storage server 300 which will store the corresponding data from the metadata server 200 to transmit the data to the storage server 300 together with the information on the corresponding storage servers 300. In this case, the client server 100 transmits the corresponding data and a storage server list to a storage server (may become an original storage server in the exemplary embodiment of the present invention) having a higher priority among the storage servers 300.

If the user requests a stored file, the client server 100 requests to the metadata server 200 metadata information of the file requested by the user. In this case, the metadata server 200 may provide to the client server 100 information of prestored metadata, for example, attribute information of the corresponding file and information on a position in which the data of the corresponding file is stored. Therefore, the client server 100 may request the data to the storage server 300 storing the data of the file requested by the user based on the information provided from the metadata server 200 and provide the data stored in the storage server 300 to the user.

The storage server 300 stores data of the user in a data block according to a request from the client server 100. In this case, the storage server 300 may be provided in plural. In this case, one of the plurality of storage servers 300 is an original storage server storing original data and at least one storage server 300 except for the original storage server is a copy storage server storing copy data.

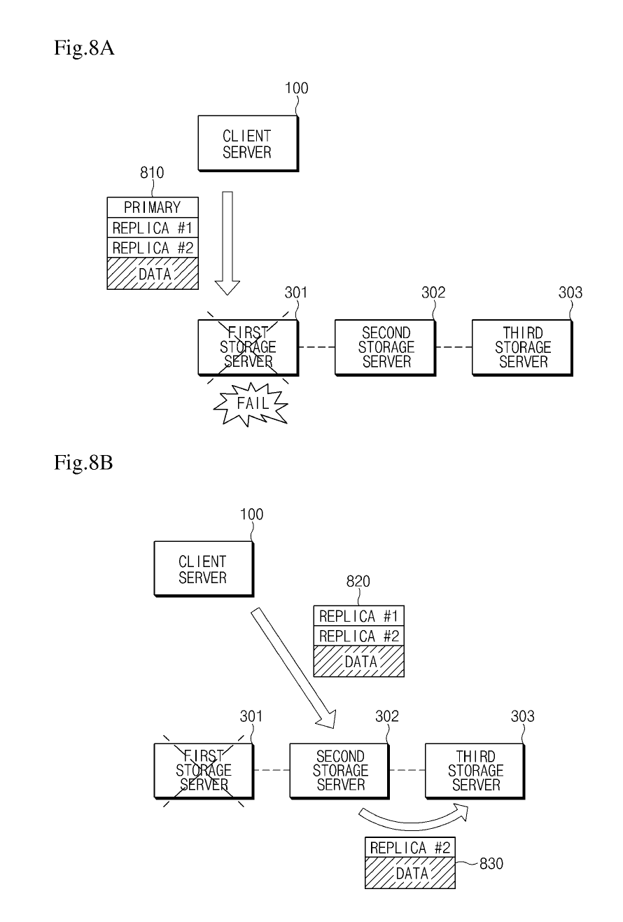

The plurality of storage servers 300 may be connected to each other through the network. Herein, each of the plurality of storage servers 300 may include a path connected with a client and a path for data replication among the respective storage servers 300. In this case, the original storage server and at least one copy storage server may sequentially store and transfer the data from the client server 100 according to a predetermined priority. A detailed description thereof will be described in more detail with reference to the exemplary embodiment of FIG. 5.

As described above, the distribution system according to the exemplary embodiment of the present invention stores the same data in the plurality of storage servers 300 to use data stored in another storage server 300 even though a failure occurs in any one storage server 300. As one example, when a failure occurs in the original storage server storing the data of the file requested by the user, the client server 100 may request the copy data stored in the copy storage server to provide the requested copy data to the user.

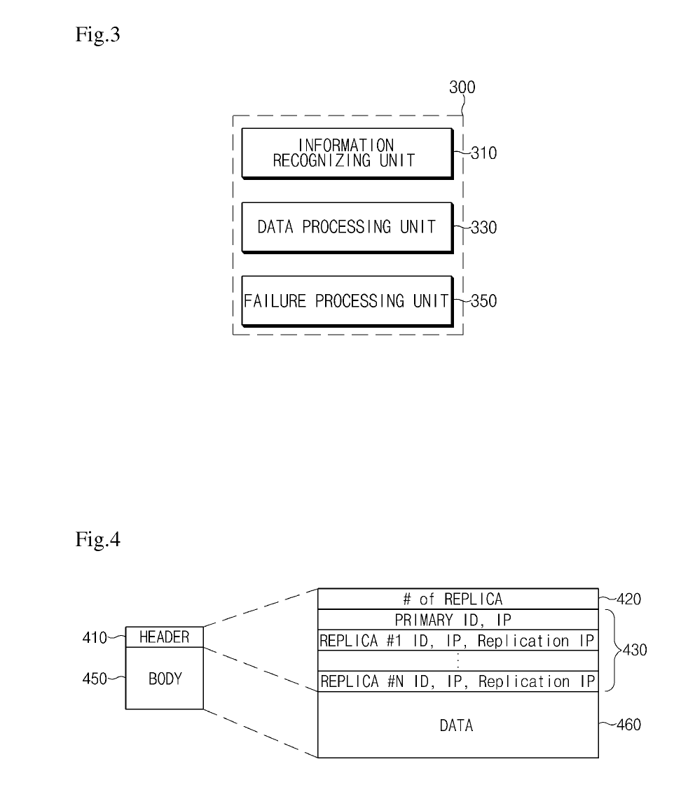

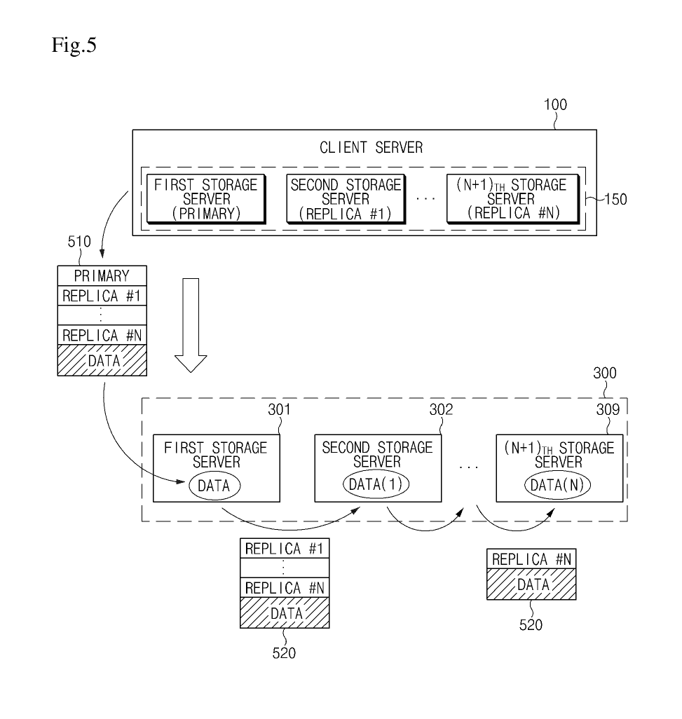

Therefore, detailed configurations of the client server 100 and the storage server 300 of the distribution system according to the exemplary embodiment of the present invention will be described in more detail with reference to FIGS. 2 and 3.

FIG. 2 is a block diagram illustrating a configuration of a client server according to the exemplary embodiment of the present invention.

Referring to FIG. 2, the client server according to the exemplary embodiment of the present invention may include a metadata management unit 110, a data management unit 130, a failure management unit 150, and a failure processing buffer 170.

The metadata management unit 110 transmits the metadata information of the corresponding file to the metadata server when there is a request for storing the file from the user and receives a request for the information corresponding to the metadata of the corresponding file from the metadata server. In this case, the metadata management unit 110 may request the information of the storage server which will store the corresponding file.

The data management unit 130 manages information on the plurality of storage servers. If there is the request for storing the file from the user, the data management unit 130 transmits and stores the data of the file which is requested to be stored by the user to and in the storage server based on the information on the plurality of storage servers, which is verified from the metadata server.

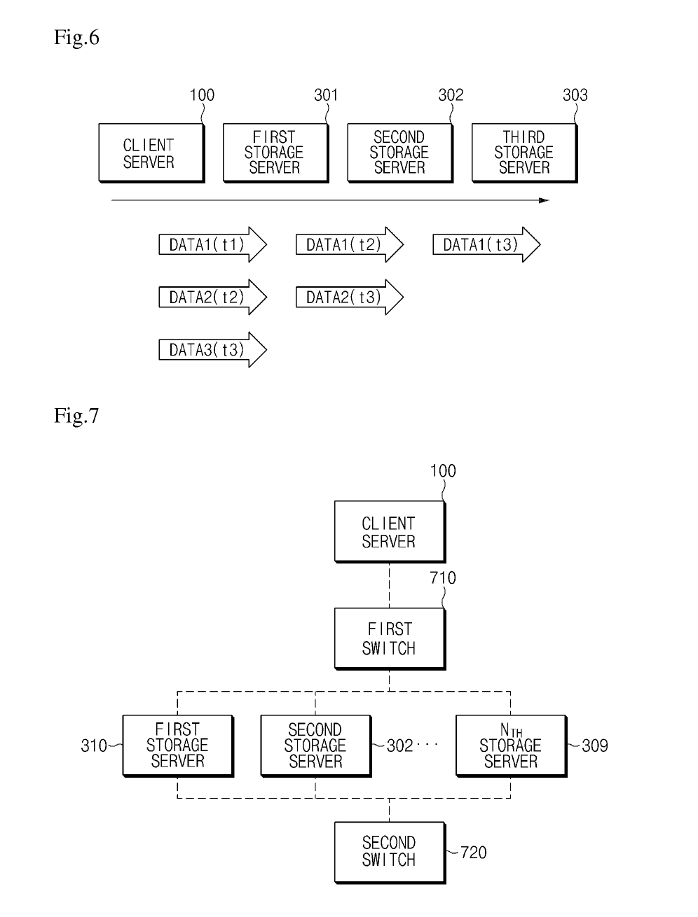

In this case, the data management unit 130 configures the storage server list including information of the original storage server and at least one copy storage server which will the data of the file which is requested to be stored by the user, and creates a message including the corresponding storage server list and the corresponding data to transmit the created message to the original storage server. Herein, the message transmitted to the original storage server by the data management unit 130 may be implemented in a structure illustrated in FIG. 4.

The data management unit 130 may store the data in the failure processing buffer 170 before transmitting the data to the original storage server. In this case, the failure processing buffer 170 is a temporary buffer and data temporarily stored in the failure processing buffer 170 may be called and retransmitted by the failure management unit 150 when the failure occurs in the storage server and data transmission is not processed.

In other words, the failure management unit 150 may receive failure occurrence information of a specific server from the storage server in which the failure occurs or the storage server transmitting the data to the storage server in which the failure occurs.

For example, in the case of failing to transmit the corresponding data due to a network failure when data is transmitted from the original storage server to a next copy storage server, the failure management unit 150 may receive network failure information regarding the next copy storage server from the original storage server. When the data is transmitted from the original storage server to the next copy storage server, in the case of failing to store the data due to a disk failure while storing the corresponding data in the next copy storage server, the failure management unit 150 may receive disk failure information regarding the next copy storage server from the next copy storage server.

In this case, the failure management unit 150 calls the data stored in the failure processing buffer 170 to retransmit the called data to the storage server in advance. Of course, even in this case, the data management unit 130 may continuously transmit the data of the user to the storage server. However, the data management unit 130 transmits the user data to storage servers other than the storage server in which the failure occurs among the storage servers included in the storage server list which will store the data.

FIG. 3 is a block diagram illustrating a configuration of a storage server according to the exemplary embodiment of the present invention.

Referring to FIG. 3, the storage server 300 according to the exemplary embodiment of the present invention may include an information recognizing unit 310, a data processing unit 330, and a failure processing unit 350.

When a message is received from the client server or a previous storage server, the information recognizing unit 310 verifies the number of data to be replicated from a header of the received message and information on the storage server list which will store the corresponding data.

The data processing unit 330 extracts data included in a body area of the message received from the client server or the previous storage server and stores the extracted data in the data block.

Meanwhile, when information on the next storage server which will replicate the corresponding data in the storage server list recognized by the information recognizing unit 310 is included, the data processing unit 330 transmits a message including a storage server list from which the corresponding storage server 300 is excluded to the next storage server.

In other words, when a list including information of first storage server, second storage server, and third storage server exists in the header of the received message, the data processing unit 330 stores data extracted from the corresponding message in a data block of the first storage server and thereafter, transmits a list including the information of the second storage server and the third storage server and a message including the corresponding data to the second storage server.

When the failure occurs during replicating the data, the failure processing unit 350 creates a notification message including the failure occurrence information to notify the created notification message to the client server.

Herein, the failure which may occur during replicating the data may correspond to a network failure and a disk failure.

First, when the network failure occurs during transmitting data among the storage servers 300, the corresponding data transmission may be failed.

For example, when the network failure occurs during transmitting the data from the original storage server to the next copy storage server, the failure processing unit 350 of the original storage server may notify to the client server network failure information regarding the next copy storage server.

Meanwhile, when the disk failure occurs during transmitting the data between the client server and the storage server 300 and among the respective storage servers 300, the storage server that receives the data may fail to store the corresponding data.

As one example, when the disk failure occurs in the original storage server in the case of transmitting the data to the original storage server from the client server, the failure processing unit 350 of the original storage server may notify the disk failure information of the original storage server to the client server.

As another example, when the disk failure occurs in the next copy storage server in the case of transmitting the data to the next copy storage server from the original storage server or the previous copy storage server, the failure processing unit 350 of the next copy storage server may notify the disk failure information of the corresponding copy storage server to the client server.

FIG. 4 is an exemplary diagram referred in describing the structure of a message transferred among respective servers in the distribution system according to the exemplary embodiment of the present invention.

In particular, FIG. 4 illustrates the structure of the message including the data to be stored in the storage server, and the message may be a message that is transmitted from the client server to the storage server or a message that is transmitted the previous storage server to the next storage server for replicating the data.

As illustrated in FIG. 4, the corresponding message is constituted by a header 410 and a body 450.

Herein, the header 410 may include the number 420 of data to be replicated to the corresponding data, for example, “# of REPLICA”. In this case, the number of data to be replicated is the number acquired by summing up both original data and copy data.

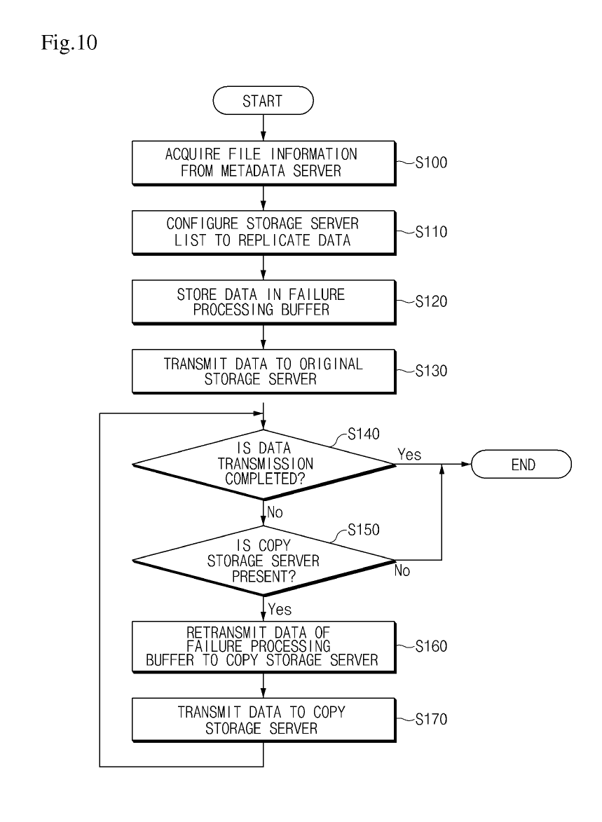

The header 410 may include a storage server list 430 which will store the corresponding data, that is, a list of an original storage server and copy storage servers. Herein, the storage server list 430 may include an ID and an IP of the corresponding storage server, and IP information regarding a data replication path. A detailed description of data replication paths among the storage servers will be made with reference to the exemplary embodiment of FIG. 7.

As one example, in the case of the message that is transmitted from the client server to the original storage server, the storage server list 430 included in the corresponding message may include “PRIMARY ID, IP” for the original storage server and “REPLICA#N ID, IP, Replication IP” for the copy storage servers.

Herein, the information of the original storage server and the original storage servers included in the storage server list is sequentially arranged according to a data storage priority of each storage server. In this case, the data storage priority of the original storage server is highest and thereafter, the priorities may be sequentially granted to the respective copy storage servers.

Meanwhile, the body 450 of the message may include actual data to be stored in the storage server.

As another example, in the case of the message that is transmitted from the original storage server or the previous copy storage server to the next copy storage server, the storage server list included in the header of the corresponding message includes information of residual storage servers other than the information of the corresponding storage server which completes storing the data, that is, the original storage server or the previous copy storage server.

FIG. 5 is an exemplary diagram referred in describing a data copying operation of the distribution system according to the exemplary embodiment of the present invention.

In FIG. 5 a first storage server represents an original storage server (PRIMARY), and a second storage server 302 to a (N+1)th storage server 309 represent copy storage servers REPLICA #1 to REPLICA #N. In FIG. 5, DATA represents original data, and DATA(1) to DATA(N) represent copy data.

Referring to FIG. 5, the client server verifies the information of the storage servers in order to store data which is requested to be stored by the user. In this case, the client server may verify the information of the storage servers that will store the data from the metadata server. Reference numeral 150 represents the information of the storage servers, which is acquired from the metadata server.

The client server configures the storage server list that will replicate the data by using the information of the storage servers acquired from the metadata server. In this case, the storage server list may include information on PRIMARY, REPLICA #1, . . . , REPLICA #N, for example, an ID, an IP, and an IP of the replication path.

The client server transmits a message 510 including the storage server list and data to be stored to a first storage server 301. Of course, the client server may store the corresponding message to the failure processing buffer before transmitting the corresponding message 510 to the first storage server 301.

In this case, the first storage server 301 that receives the message 510 from the client server stores the data DATA included in the received message 510 in the data block. The first storage server 301 verifies the information on the second storage server 302 that will replicate the corresponding data from the storage server list included in the message 510 and transmits a message 520 to the second storage server 302. In this case, the first storage server 301 transmits to the second storage server 302 the message 520 including information of residual storage servers other than the information of the first storage server 301 from the storage server list, for example, information on REPLICA #1, . . . , REPLICA #N together with the data.

The second storage server 302 that receives the message from the first storage server 301 stores the data included in the received message 520 in the data block. The second storage server 302 verifies the information of the next storage server that will replicate the corresponding data from the storage server list included in the message 520 and transmits the message to the next storage server. Similarly the second storage server 302 transmits the message including information of residual storage server other than the information on the second storage server 302 from the storage server list together with the data.

By such a scheme, a last (N+1)th storage server 309 which will replicate the data may receive a message including the information on REPLICA #N and the data from the Nth storage server. In this case, since the message received by the (N+1)th storage server 309 does not include the information on the next storage server that will replicate the data, the (N+1)th storage server 309 stores the data included in the message 530 in the data block and ends associated operations.

In this case, except for the case where the failure occurs during the transmitting the message including the storage server list and the data, when each storage server receives the message, each storage server immediately stores the data without separate response processing and thereafter, transmits the message to the next storage server.

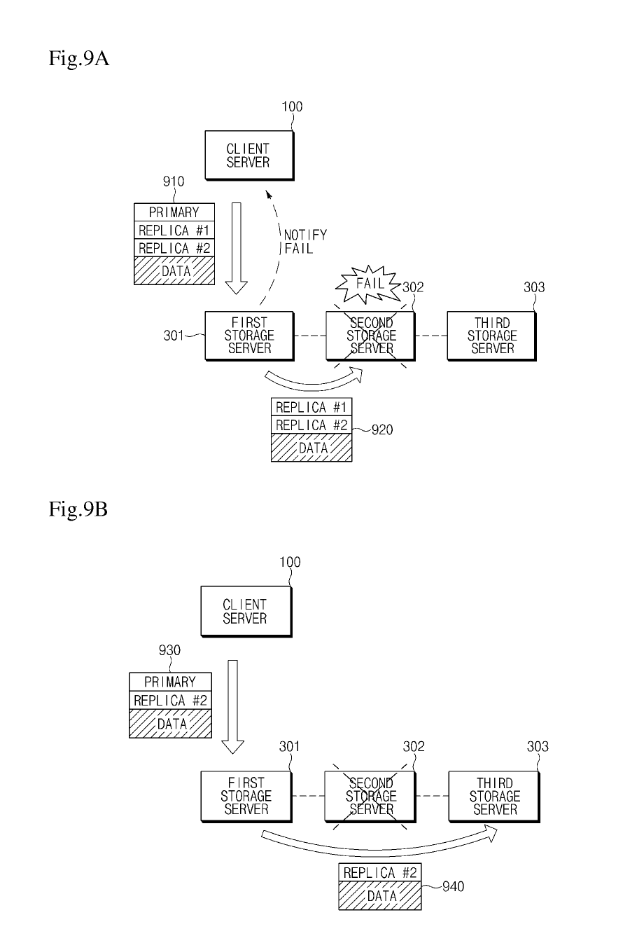

FIG. 6 is an exemplary diagram illustrating a data flow of the distribution system according to the exemplary embodiment of the present invention.

FIG. 6 illustrates the flow of data transferred among the client server, the first storage server 301, the second storage server 302, and the third storage server 303.

The client server may sequentially transmit DATA1, DATA2, and DATA3 to the first storage server 301.

In other words, the client server transmits the DATA1 to the first storage server 301 at a time t1. Therefore, the first storage server 301 stores the DATA1 received from the client server.

Thereafter, the client server transmits the DATA2 to the first storage server 301 at a time t2 without waiting for a response to the DATA1 from the first storage server 301. In this case, since the first storage server 301 does not perform response processing to the DATA1, the first storage server 301 subsequently transmits the DATA1 received from the client server to the second storage server 302. Therefore, since the first storage server 301 has already transmitted the DATA1 to the second storage server 302 at the time t2 of receiving the DATA2 from the client server, a delay time is not almost generated during recording the DATA2.

The client server transmits the DATA2 to the first storage server 301 at the time t2 and subsequently transmits the DATA3 to the first storage server 301 at a time t3. Even in this case, since the first storage server 301 transmits the DATA2 to the second storage server 302 without response processing to the DATA2, the delay time is not almost generated during recording the DATA3.

Similarly, when the DATA2 is transmitted from the first storage server 301 to the second storage server 302, the delay time is not almost generated during recording the DATA2 in the second storage server 302.

Of course, the time when the storage server transmits the DATA1 to the next storage server and the time when the storage server receives the DATA2 from the previous storage server may not coincide with each other, but the delay time may be minimized in that the DATA1 and the DATA2 are not simultaneously stored.

FIG. 7 is an exemplary diagram illustrating an inter-storage server connection structure according to the exemplary embodiment of the present invention.

Referring to FIG. 7, in each of the plurality of storage servers, a first network path connected with the client server and a second network path through which the message is transmitted for data replication may be separately implemented.

In other words, each of the first storage server 301 to the (N+1)th storage server 309 may be connected with the client server through the first network path. In this case, a first switch 710 may be provided on the first network path and the message received from the client server may be transferred to the corresponding storage server by a switching operation of the first switch 710.

When the message including the storage server list and the data is transmitted from the client server, the first switch 710 may transfer the message to a highest-layer server on the storage server list. In this case, since the first storage server 301 is in top priority, the first switch 710 transmits the message transmitted from the client server to the first storage server 301.

However, when the failure occurs in the first storage server 301, the first storage server 301 is excluded from the storage server list, and as a result, the second storage server 302 becomes the highest-layer server. Accordingly, the first switch 710 may transmit the message from the client server, to the second storage server 302.

Meanwhile, the first storage server 301 to the (N+1)th storage server 309 may be connected with each other the second network path. In this case, a second switch 720 may be provided on the second network path and the message for the data replication may be transferred by the second switch 720.

As one example, when the message including the storage server list and the data from the first storage server 301 through the second network path for the data replication, the second switch 720 transfers the second storage server 302 following the corresponding message to the highest-layer server on the storage server list, that is, the first storage server 301. Of course, when the information of the second storage server 302 is not present on the storage server list as the failure occurs in the second storage server 302, the corresponding message is transferred to the third storage server 303.

By such a scheme, the second switch 720 may transfer the message for the data replication up to the (N+1)th storage server 309.

Herein, the first switch 710 and the second switch 720 are network switches that switch a network path.

As described above, in the present invention, since a network path for a communication service between the client server and the storage server and the network path for the data replication are separately configured, service network traffics and replication network traffics are separately processed to prevent the quality of the service network from being deteriorated due to the data replication.

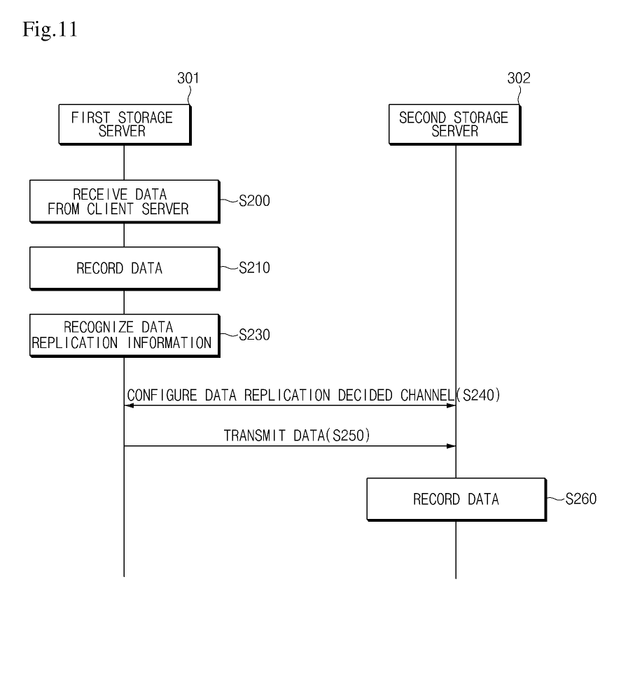

FIGS. 8A to 9B are exemplary diagrams referred in describing a failure processing operation of the distribution system according to the exemplary embodiment of the present invention.

FIGS. 8A and 8B illustrate a failure processing operation when the failure occurs in the original storage server.

As illustrated in FIG. 8A, the client server configures a message 810 including the storage server list constituted by the information on the storage servers, for example, the first storage server (PRIMARY) 301, the second storage server (REPLICA #1) 302, and the third storage server (REPLICA #2) 303 and the data, and stores the configured message 810 in the failure processing buffer and transmits the message 810 to the first storage server 301 which is the original storage server.

In the case of failing to transmit the message due to the network failure in the first storage server 301 during transmitting the message 810 from the client server to the first storage server 301, the client server may sense a failure state of the first storage server 301. In this case, the client server stops transmitting the message to the first storage server 301 in which the failure occurs and transmits the information of the first storage server 301 to the metadata server to remove the information of the first storage server 301 from the information of the corresponding file.

As described above, when the failure occurs in the first storage server 301, the client server creates a message 820 including the storage server list constituted by the information on the residual storage servers 2 and 3 (REPLICA #1 and REPLICA #2 302 and 303 other than the first storage server 301 in which the failure occurs and the data stored in the failure processing buffer again and transmits the created message 820 to the second storage server 302, as illustrated in FIG. 8B.

In this case, the second storage server 302 that receives the message 820 from the client server stores the data DATA included in the received message 820 in the data block. Thereafter, the second storage server 302 verifies information on the third storage server 303 that will replicate the corresponding data from the storage server list included in the message 820, and configures a message 830 including the storage server list including the information on the third storage server (REPLICA #2) 303 and the data and transmits the corresponding message 830 to the third storage server 303.

FIGS. 9A and 9B illustrate the failure processing operation when the failure occurs in the copy storage server.

As illustrated in FIG. 9A, the client server configures a message 910 including the storage server list constituted by the information on the storage servers, for example, the first storage server (PRIMARY) 301, the second storage server (REPLICA #1) 302, and the third storage server (REPLICA #2) 303 and the data, and stores the configured message 910 in the failure processing buffer and transmits the message 910 to the first storage server 301 which is the original storage server.

In this case, the first storage server 301 that receives the message 910 from the client server stores the data DATA included in the message 920 in the data block. Thereafter, the first storage server 301 verifies information on the third storage server 303 that will replicate the corresponding data from the storage server list included in the message 910, and configures a message 920 including the storage server list including the information on the second storage server (REPLICA #1) 302 and the third storage server (REPLICA #2) 303 and the data and transmits the corresponding message 920 to the second storage server 303.

In the case of failing to transmit the message due to the network failure of the second storage server 302 during transmitting the message 920 from the first storage server 301 to the second storage server 302, the first storage server 301 may sense a failure state of the storage 2 302. In this case, the first storage server 301 stops transmitting the message to the second storage server 302 in which the failure occurs and notifies to the client server the failure occurrence information regarding the second storage server 302.

In this case, the client server creates a message 930 including the storage server list constituted by the information on the residual storage servers 1 and 3 (PRIMARY and REPLICA #2) 301 and 303 other than the second storage server 302 in which the failure occurs and the data stored in the failure processing buffer again and transmits the created message 930 to the first storage server 301, as illustrated in FIG. 9B.

In this case, the client server preferentially transmits the data stored in the failure processing buffer to the storage servers 301 and 303 and thereafter, retransmits the data at the time when the failure occurs.

Therefore, the first storage server 301 stores in the data block the data DATA included in the message 930 received from the client server, and verifies the information of the third storage server 303 that will replicate the data from the storage server list and transmits a message 940 including the storage server list including the information on the third storage server (REPLICA #2) 303 and the data to the third storage server 303.

An operation flow of the distribution system according to the present invention, which is configured as above will be described below in more detail.

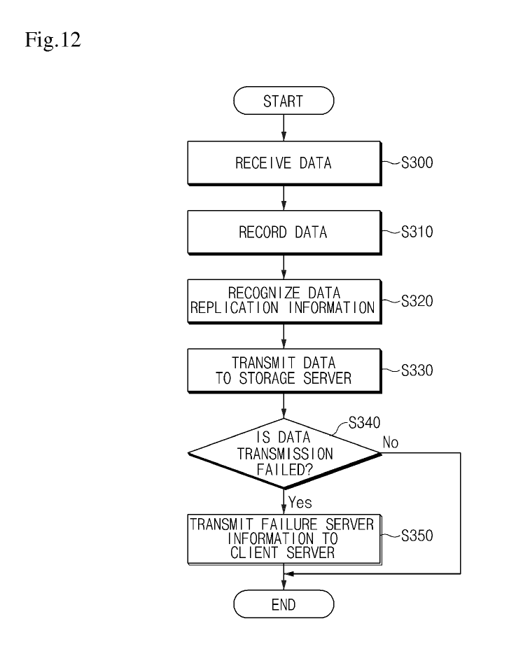

FIGS. 10 to 12 are flowcharts illustrating an operation flow of a distribution system according to another exemplary embodiment of the present invention.

FIG. 10 is a flowchart illustrating an operation flow of a client server according to the present invention.

Referring to FIG. 10, when there is a request for storing a file from a user, the client server provides metadata information of the corresponding file to a metadata server to acquire information of storage servers that will store the corresponding file (S100).

Thereafter, the client server temporarily stores in a failure processing buffer data of the file which is requested to be stored by the user (S110) and transmits data to an original storage server based on the information of the storage servers acquired during ‘S100’ (S120). In this case, the client server configures a storage server list including related information according to a priority of the storage servers acquired during ‘S100’ to transmit the storage server list together with the data.

Of course, during ‘S120’, it is assumed that a failure does not occur in the original storage server. In this case, the client server may transmit the data to a storage server having a higher priority according to the priority of the storage servers acquired during ‘S100’.

Since the data transmitted to the original storage server during ‘S120’ is transmitted to a copy storage server having a next priority by the original storage server, the client server ends a related operation when data transmission is completed (S130).

Meanwhile, in the case of failing to transmit the data due to a network failure of the original storage server during ‘S130’, the client server verifies information of a copy storage server having a higher priority among copy storage servers other than the original storage server in which the failure occurs in the information of the storage servers, which is acquired during ‘S100’, calls the data stored in the failure processing buffer during ‘S110’ and retransmits the called data to the corresponding copy storage server, and thereafter, transmits the data which is requested to be stored by the user to the corresponding copy storage server (S160).

FIG. 11 is a flowchart illustrating an operation flow among storage servers according to the present invention. In FIG. 11, the first storage server 301 represents the original storage server and the second storage server 302 represents the copy storage server.

Referring to FIG. 11, when the first storage server 301 receives the data which is requested to be stored by the user from the client server (S200), the first storage server 301 records the corresponding data in the data block (S210).

The first storage server 301 may receive both the corresponding data and the storage server list at the time of receiving the data during ‘S200’. Therefore, the first storage server 301 recognizes replication information on the corresponding data, for example, information of residual copy storage servers other than the first storage server 301 from the storage server list received together with the data (S230).

Thereafter, the first storage server 301 configures a dedicated channel for data replication between the second storage server 302 corresponding to the next order and the first storage server 301 among the copy storage servers (S240) and transmits the data through the channel configured during ‘S240’ (S250).

Therefore, the second storage server 302 records the data received from the first storage server 301 in the data block (S260).

Thereafter, the second storage server 302 also performs operations corresponding to ‘S200’ to ‘S250’ similarly to the first storage server 301 to transmit the data to the next copy storage server.

FIG. 12 is a flowchart illustrating a failure processing operation flow of the copy storage server according to the present invention. The operations of FIG. 12 represent an exemplary embodiment when the network failure occurs in the next storage server during transmitting the data to the next storage server from the storage server and the corresponding storage server may be the copy storage server and the copy storage server.

Referring to FIG. 12, when the storage server receives the data (S300), the storage server records the corresponding data in the data block (S310).

In this case, the storage server may receive both the corresponding data and the storage server list at the time of receiving the data during ‘S300’. Accordingly, the storage server recognizes the information of the residual storage servers other than the replication information on the corresponding data, for example, the information on the storage server from the storage server list received together with the data (S320).

Thereafter, the storage server transmits the corresponding data to the next storage server among the storage servers recognized during ‘S230’ (S330).

When transmitting the data to the next storage server is completed during ‘S330’ (S340), the storage server ends the related operation.

On the contrary, in the case of failing to transmit the data due to the network failure of the next storage server during ‘S340’, the information of the next storage server in which the network failure occurs is transmitted to the client server (S350) and a failure state is notified.

Accordingly, the client server verifies the failure state of the storage server and configures a storage server list for residual storage servers other than a storage server in which the failure occurs thereafter to transmit the data.

Meanwhile, the present invention can be implemented by a processor readable code in a processor readable recording medium when various exemplary embodiments discussed above are executed by one or more computers or processors. The processor-readable recording medium includes all kinds of recording apparatuses in which processor-readable data are stored. Examples of the processor readable recording medium include ROM, RAM, CD-ROM, a magnetic tape, a floppy disk, an optical data storing device and the processor readable recording medium may also be implemented in a form of a carrier wave such as transmission through the Internet. The processor-readable recording medium is distributed in a computer system connected to a network, and the processor-readable code may be stored and executed by a distribution method.

The specified matters and limited embodiments and drawings such as specific components in the present invention have been disclosed for illustrative purposes, but are not limited thereto, and those skilled in the art will appreciate that various modifications and changes can be made in the art to which the present invention belongs, within the scope without departing from an essential characteristic of the present invention. The spirit of the present invention should not be defined only by the described exemplary embodiments, and it should be appreciated that and claims to be described below and all technical spirits which evenly or equivalently modified are included in the claims of the present invention.

What is claimed is:

1. An apparatus for distribution processing of data, the apparatus comprising:
a metadata management unit providing metadata information corresponding to data to a metadata server to verify information of an original storage server and one or more copy storage servers to store the data from the metadata server; and
a data management unit creating a message including the information on the storage servers verified by the metadata management unit and the data, and transmitting the message to a storage server having a higher priority according to priorities of the storage servers to store the corresponding data.

2. The apparatus of claim 1, wherein the information on the storage servers is implemented in a storage server list form in which the information of the respective storage servers is sequentially sorted according to the priorities of the storage servers.

3. The apparatus of claim 2, wherein in the message, the storage server list is included in a header area and the data is included in a body area.

4. The apparatus of claim 1, wherein the information on the storage servers includes at least one of an ID and an IP of each storage server, and a replication path IP of the data included in the message.

5. The apparatus of claim 1, further comprising:
a failure processing buffer temporarily storing the message before transmitting the message.

6. The apparatus of claim 5, further comprising:
a failure management unit calling the message temporarily stored in the failure processing buffer to retransmit the called message to the storage server having the higher priority among residual servers other than the storage server in which the failure occurs.

7. The apparatus of claim 1, wherein the original storage server has a higher priority than the copy storage servers.

8. A storage server comprising:
an information recognizing unit recognizing, from a message including a storage server list and data, information on a plurality of storage servers included in the storage server list; and
a data processing unit extracting the data from the message and storing the extracted data in a data block and transmitting the data to the next storage server according to priorities of the plurality of storage servers recognized by the information recognizing unit.

9. The storage server of claim 8, wherein the data processing unit reconfigures a storage server list in which information of residual storage servers other than information on the data processing unit is sequentially sorted according to the priorities of the storage servers to transmit the reconfigured storage server list to the next storage server together with the data.

10. The storage server of claim 8, further comprising:
a failure processing unit transmitting a disk failure state of the corresponding storage server to a data distribution processing apparatus in the case of failing to store the data due to occurrence of a failure in the data block.

11. The storage serve of claim 10, wherein the failure processing unit transmits a network failure state of the next storage server to the data distribution processing apparatus in the case of failing to transmit the data to the next storage server.

12. The storage serve of claim 8, wherein the message stores the data and is asynchronously transmitted through a replication dedicated channel formed among the next storage servers.

13. A method for distribution processing of data; the method comprising:
providing metadata information corresponding to data to a metadata server to verify information of an original storage server and one or more copy storage servers to store the data from the metadata server;
creating a message including the verified information on the storage servers and the data;
temporarily storing the message in a failure processing buffer; and
transmitting the message to a storage server having a higher priority according to priorities of the storage servers.

14. The method of claim 13, wherein the information on the storage servers is implemented in a storage server list form in which the information of the respective storage servers is sequentially sorted according to the priorities of the storage servers to be included in a header of the message.

15. The method of claim 14, wherein the message is sequentially transferred to the respective storage servers according to the priority of the storage server included in the storage server list.

16. The method of claim 13, wherein the information on the storage servers includes at least one of an ID and an IP of each storage server, and a replication path IP of the data included in the message.

17. The method of claim 16, wherein the message stores the data and is asynchronously transferred through a replication dedicated channel formed among the respective storage servers based on a replication path IP of the data for each storage server.

18. The method of claim 13, further comprising:
sensing a failure state of any one of the storage servers; and
calling the message temporarily stored in the failure processing buffer and retransmitting the called message to a storage server having a higher priority among residual servers other than a storage server in which the failure occurs.
